(19) United States
(12) Patent Application Publication
(10) Pub. No.: US 2018/0340696 A1
(43) Pub. Date: Nov. 29, 2018

(54) WATER HEATING APPARATUS UTILIZING PHOTOVOLTAIC AND THERMAL ENERGY

(71) Applicant: Shi Hong Zhang, Chengdu (CN)

(72) Inventor: Shi Hong Zhang, Chengdu (CN)

(21) Appl. No.: 15/987,807

(22) Filed: May 23, 2018

Related U.S. Application Data
(60) Provisional application No. 62/509,772, filed on May 23, 2017.

(51) Int. Cl. F24D 3/00; F24S 20/40; H02S 40/44

(52) U.S. Cl. CPC F24D 3/005; H02S 40/44; F24S 20/40

(57) ABSTRACT

In one aspect, a photovoltaic energy and thermal energy generated water and heat supply integral unit includes a photovoltaic energy accumulator, a photovoltaic hot plates, a thermal energy vacuum-boiler and water-use sites. The photovoltaic energy accumulator is connected with photovoltaic hot plates. A water outlet of the photovoltaic energy accumulator is connected with a water inlet of thermal energy vacuum boiler. The water outlet of thermal energy vacuum boiler is connected with a water inlet of photovoltaic energy accumulator. When in use, the photovoltaic hot plate to absorb surrounding light energy and transform it into electrical energy for heating water, and surplus energy is to be stored in the photovoltaic energy accumulator. Meanwhile, the thermal energy module of the thermal energy vacuum boiler is used to generate thermal energy to effectively use the renewable resources from the surrounding environment.

### FIELD OF THE INVENTION

The present invention is related to a water heating apparatus, and more particularly to a water heating apparatus utilizing photovoltaic and thermal energy.

### BACKGROUND OF THE INVENTION

With the over-exploitation and overuse of non-renewable energy, renewable energies such as wind energy and solar energy are playing an increasingly important role. Conventional solar water heating systems mainly rely on solar modules to receive sunlight to increase the temperature of the solar modules to further heat the relatively low-temperature water inside and generate hot water. The theory that the hot water will be floating while the cold water will be sinking is used to cause the natural circulation of water. The water with higher temperature is pumped into hot water tank by pump for use. In cloudy days or winter days, when the solar radiation is not strong enough, energies like natural gas or coal will be used to supplement the conventional water heating system. However, solar energy is the only energy source for each existing solar water heating systems, and the energy supplementation for these systems will cause a waste since part of the energy supplementation is discharged as smoke. Therefore, there remains a need for a new and improved water heating apparatus to overcome the problems stated above.

### SUMMARY OF THE INVENTION

The purpose of present invention is to provide a water heating apparatus utilizing photovoltaic and thermal energy to maximize the efficient for water and heat generation. Meanwhile, other forms of energy are used for thermal energy supplement to further enhance energy efficiency.

In one embodiment, a photovoltaic energy and thermal energy generated water and heat supply integral unit includes a photovoltaic energy accumulator, a photovoltaic hot plate, a thermal energy vacuum-boiler and water-use sites. The photovoltaic energy accumulator is connected with photovoltaic hot plates. A water outlet of the photovoltaic energy accumulator is connected with a water inlet of thermal energy vacuum boiler. The water outlet of thermal energy vacuum boiler is connected with a water inlet of photovoltaic energy accumulator. And in this way a loop circuit is formed. Water-use site is to be made between the water outlet of thermal energy vacuum boiler and the water inlet of photovoltaic energy accumulator. Meanwhile, the water inlet of photovoltaic energy accumulator is connected with water source to achieve water ingress. The air inlet of the thermal energy vacuum boiler is connected with air source to achieve air intake. The exhaust vent of the thermal energy vacuum boiler is connected with the chimney.

The photovoltaic hot plates are to absorb all surrounding light energy effectively, which in term transforms into electricity for heating water. And surplus energy will be stored in the photovoltaic energy accumulator. Meanwhile, the thermal energy module of the thermal energy vacuum boiler is used to generate thermal energy, so as to maximize the use of the renewable resources from the surrounding environment.

When the use of water is increased at the water-use site, the gas which enters the combustor of the thermal energy vacuum boiler will burn to generate auxiliary heating towards the water inside the heat-transferring tube, to guarantee invariable water temperature in the loop circuit of the photovoltaic energy and thermal energy generated water and heat supply integral unit.

Furthermore, thermal energy vacuum boiler includes the combustion chamber, the thermal energy module and the heat-transferring tube. The air inlet is connected with the combustion chamber and the thermal energy module. The exhaust vent is connected with the combustion chamber and the thermal energy module. The water inlet and the water outlet are arranged on the heat-transferring tube. The heat-transferring tube is located above the combustion chamber and the thermal energy module. When the water flows into the heat-transferring tube, it will heat the water with the thermal energy from the combustion in the combustion chamber below the heat-transferring tube, and the thermal energy transferred from thermal energy in the thermal energy module.

Further, a heat recovery device is also included. Water inlet, water outlet, air inlet and air outlet are arranged on the heat recovery device. The water inlet on the heat recovery device is connected with the water outlet on the photovoltaic energy accumulator. The water outlet on the heat recovery device is connected with the water inlet on the thermal energy vacuum boiler. The air inlet on the heat recovery device is connected with air outlet on the thermal energy vacuum boiler. The air outlet on the heat recovery device is connected with the chimney. The adoption of the heat recovery device makes full use of the air source for auxiliary heating, so as to enhance the effective utilization of non-renewable resources. In one embodiment, the heat recovery device is with a membrane wall.

Furthermore, it also includes two valves, respectively installed at water resource inlet of the photovoltaic energy accumulator and at water outlet of thermal energy vacuum boiler that is connected to water inlet of the photovoltaic energy accumulator, so as to facilitate the control of the water coming into and out of the photovoltaic energy and thermal energy generated water and heat supply integral unit, to meet the need for maintenance of unit, and at the same time to control the water pressure in the loop circuit of the photovoltaic energy and thermal energy generated water and heat supply integral unit.

Comparing with conventional heat generating apparatus, the present invention is advantageous because the combination of the photovoltaic energy accumulator with the thermal energy module of the thermal energy vacuum boiler can make full use of energy commonly existed in the environment, to maximize the use of the renewable resources therefrom. Furthermore, the application of the heat recovery device makes full use of the air source for auxiliary heating to enhance the efficiency of using non-renewable resources.

The use of valves is to facilitate the control of the water coming into and out of the photovoltaic energy and thermal energy generated water and heat supply integral unit, to meet the need for maintenance of unit, and at the same time to control the water pressure in the loop circuit of the photovoltaic energy and thermal energy generated water and heat supply integral unit to stabilize water pressure to avoid the situation of low water pressure.

### BRIEF DESCRIPTION OF THE DRAWINGS

FIG. 1 is schematic view of the water heating apparatus in the present invention.

FIG. 2 is schematic view of the thermal energy vacuum boiler in the present invention.

Among which, 1 for photovoltaic energy accumulator; 1.1 for water inlet; 1.2 for water outlet; 2 for photovoltaic hot plate; 3 for heat recovery device; 3.1 for water inlet; 3.2 for water outlet; 3.3 for air inlet; 3.4 for air outlet; 4 for chimney; 5 for thermal energy vacuum boiler; 5.1 for water inlet; 5.2 for exhaust vent; 5.3 for water outlet; 5.4 for air inlet; 5.5 for heat-transferring tube; 5.6 for thermal energy module; 5.7 for combustor; 6 for water-use site; 7 for valve; 8 for valve.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

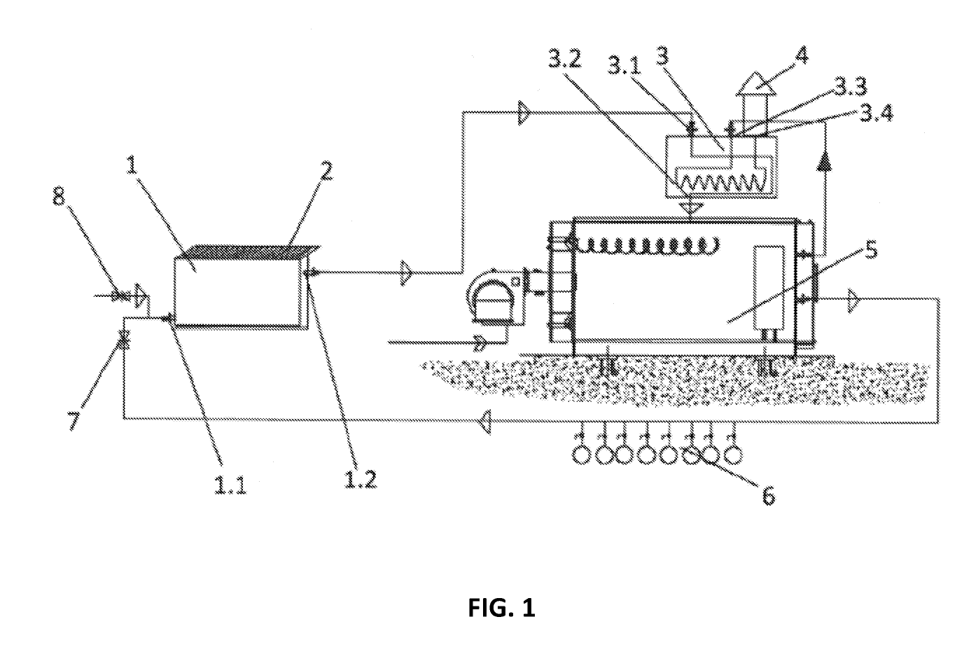

Referring to FIG. 1, a photovoltaic energy and thermal energy generated water and heat supply integral unit may include a photovoltaic energy accumulator 1, a thermal energy vacuum boiler 5, a water-use site 6 and a membrane walled heat recovery device 3. The photovoltaic energy accumulator 1 may include a photovoltaic hot plate 2, a water inlet 1.1 and a water outlet 1.2.

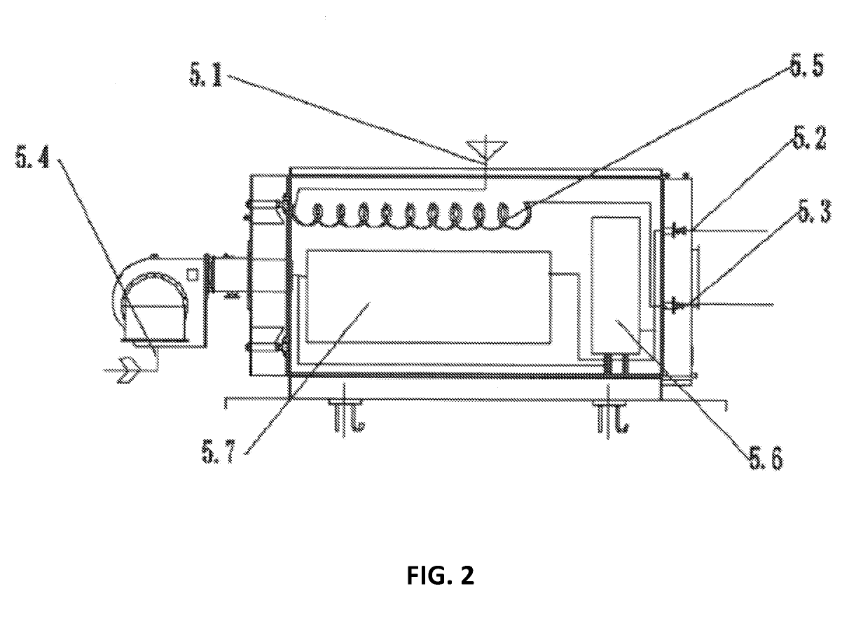

As shown in FIG. 2, the thermal energy vacuum boiler 5 includes combustor 5.7, thermal energy module 5.6, and hear-transferring tube 5.5; and combustor 5.7 is connected to air inlet 5.4 and exhaust vent 5.2, and thermal energy module 5.6 is also connected to air inlet 5.4 and exhaust vent 5.2, and both terminals of hear-transferring tube 5.5 are respectively connected to water inlet 5.1 and water outlet 5.3, and hear-transferring tube 5.5 is above combustor 5.7 and thermal energy module 5.6. Heat recovery device 3 is with water inlet 3.1, water outlet 3.2, air inlet 3.3 and air outlet 3.4. Water outlet 1.2 of photovoltaic energy accumulator is connected to water inlet 3.1 of heat recovery device. The water outlet 3.2 of heat recovery device is connected with water inlet 5.1 of thermal energy vacuum boiler. The water outlet 3.3 of heat recovery device is connected with water inlet 5.2 of thermal energy vacuum boiler. The air outlet 3.4 of heat recovery device is connected with the chimney 4. Water outlet 5.3 of thermal energy vacuum boiler is connected to water inlet 1.1 of photovoltaic energy accumulator, and one valve 7 is installed in this water inlet. Photovoltaic energy accumulator 1, thermal energy vacuum boiler 5 and membrane walled heat recovery device 3 form a loop circuit. A water-use site 6 is located between water inlet 1.1 of photovoltaic energy accumulator and water outlet 5.3 of thermal energy vacuum boiler; water inlet 1.1 of photovoltaic energy accumulator is also connected to the incoming water source and air inlet 5.4 of thermal energy vacuum boiler is connected to incoming air source. At water inlet 1.1 of photovoltaic energy accumulator, there is another valve 8, controlling the incoming of water resource.

When in use, the photovoltaic hot plate of photovoltaic energy accumulator absorbs all surrounding light energy effectively, which in term transforms into electricity for heating water, and this electricity will conduct initial heating of water within tube. The heated water flows past the heat recovery device into heat-transferring tube of thermal energy vacuum boiler. And the thermal energy module of the thermal energy vacuum boiler conducts a secondary heating of water. The further heated water is to supply the water-use site via pipe, and the surplus hot water will flow back to photovoltaic energy accumulator and, together with the later-coming water, flows out of water outlet of photovoltaic energy accumulator after heating.

When the water use volume increases at the water-use site or when the temperature is yet up to demand, natural gas flows from inlet of thermal energy vacuum boiler in to combustor and begins to burn and conduct supplementary heating of water within heat-transferring tube. Water heated by thermal energy and natural gas flows into water-use site via water outlet, or flows back to photovoltaic energy accumulator. The burnt natural gas flows via the exhaust vent of thermal energy vacuum boiler into the air inlet of heat recovery device to conduct surplus heating on water flowing into the heat recovery device, and the exhaust gas flows through air outlet of heat recovery device into the chimney. Hot water heated by photovoltaic energy and surplus heat flows into thermal energy vacuum boiler for a secondary heating, so as to guarantee water temperature within loop circuit of the photovoltaic energy and thermal energy generated water and heat supply integral unit is stable and meets demand for water use. When using water, water inlet valve of photovoltaic energy accumulator is open, so as to guarantee that water pressure of the photovoltaic energy and thermal energy generated water and heat supply integral unit is stable lest there occurs a low water-supply pressure.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A photovoltaic apparatus for providing heat and water comprising: a photovoltaic energy accumulator, a photovoltaic hot plate and an air energy vacuum-boiler,
wherein the photovoltaic energy accumulator is connected to the photovoltaic hot plate, and a water outlet of the photovoltaic energy accumulator is connected to a water inlet of the air energy vacuum boiler, and a water outlet of air energy vacuum boiler is connected to a water inlet of photovoltaic energy accumulator to form a loop, and the water inlet of photovoltaic energy accumulator is connected to a water source for water ingress,
wherein an air inlet of the air energy vacuum boiler is connected to air source to achieve air intake and an exhaust vent of the air energy vacuum boiler is connected to a chimney.

2. The photovoltaic apparatus for providing heat and water of claim 1, wherein the air energy vacuum boiler includes a combustion chamber, an air energy module and a heat-transferring tube, the air inlet is connected with the combustion chamber and the air energy module, the exhaust vent is connected with the combustion chamber and the air energy module, the water inlet and the water outlet are arranged on the heat-transferring tube, and the heat-transferring tube is located above the combustion chamber and the air energy module.

3. The photovoltaic apparatus for providing heat and water of claim 2, further comprising a heat recovery unit having a water inlet, water outlet, air inlet and air outlet are arranged thereon; the water inlet of the heat recovery unit is connected with the water outlet of the photovoltaic energy accumulator; the water outlet of the heat recovery unit is connected with the water inlet of the air energy vacuum boiler; the air inlet of the heat recovery unit is connected with the air outlet of the air energy vacuum boiler, and the air outlet of the heat recovery unit is connected with the chimney.

4. The photovoltaic apparatus for providing heat and water of claim 3, wherein the heat recovery unit is a membrane-style heat recovery unit.

5. The photovoltaic apparatus for providing heat and water of claim 1, further comprising a pair of valves, one of which located at the water source of the photovoltaic energy accumulator, and the other of which located at the water outlet of the air energy vacuum boiler that is connected to the water inlet of the photovoltaic energy accumulator.

6. The photovoltaic apparatus for providing heat and water of claim 1, further comprising a water usage site located between the water outlet of air energy vacuum boiler and the water inlet of photovoltaic energy accumulator.
